(19) United States
(12) Patent Application Publication
(10) Pub. No.: US 2018/0287953 A1
(43) Pub. Date: Oct. 4, 2018

(54) GENERIC QUEUE

(71) Applicant: Intel Corporation, Santa Clara, CA (US)

(72) Inventors: Albert S. CHENG, Bellevue, WA (US); Michael A. PARKER, Santa Clara, CA (US); Thomas D. LOVETT, Portland, OR (US); Steven F. HOOVER, Hudson, MA (US)

(21) Appl. No.: 15/531,692

(22) PCT Filed: Dec. 23, 2014
(86) PCT No.: PCT/US2014/072203

§ 371 Date: May 30, 2017

(51) Int. Cl. H04L 12/863

(52) U.S. Cl. CPC H04L 47/6205; H04L 47/6235

(57) ABSTRACT

Apparatuses, methods and storage medium associated with the placement of data packets in one or more queues of a switch are described herein. In embodiments, the switch may include a plurality of virtual lane (VL) queues (VLQs) and a plurality of generic queues (GQs). A queue manager may be configured to selectively place a packet of a particular VL in a corresponding VLQ or a GQ. Other embodiments may be described and/or claimed.

### TECHNICAL FIELD

The present disclosure relates to the field of networking. More particularly, the present disclosure relates to data queue organization and assignment for packets in a switch.

### BACKGROUND

The background description provided herein is for the purpose of generally presenting the context of the disclosure. Unless otherwise indicated herein, the materials described in this section are not prior art to the claims in this application and are not admitted to be prior art by inclusion in this section.

Legacy input-queued switches may experience performance problems due to head-of-line (HOL) blocking. HOL blocking may refer to a situation wherein a data packet at the head of a data queue is unable to be serviced due to a conflict related to one or more resources of the switch. Because the packet is unable to be serviced, the packet may not be transferred out of the queue. As a result, the blocked packet may prevent service of any packets behind it in the queue, even if those packets would not have the same resource conflict.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 illustrates a block diagram of a switch that includes virtual lane queues (VLQs) and generic queues (GQs), in accordance with various embodiments.

FIG. 2 illustrate a process for placing a packet in a VLQ or a GQ, in accordance with various embodiments.

FIG. 3 illustrates an alternative process for placing a packet in a VLQ or a GQ, in accordance with various embodiments.

FIG. 4 illustrates an alternative process for placing a packet in a VLQ or a GQ, in accordance with various embodiments.

FIG. 5 illustrates an alternative process for placing a packet in a VLQ or a GQ, in accordance with various embodiments.

FIG. 6 illustrates an example computer system suitable for use to practice various aspects of the present disclosure, in accordance with various embodiments.

FIG. 7 illustrates a storage medium having instructions for practicing processes described with references to FIGS. 2-5, in accordance with various embodiments.

### DETAILED DESCRIPTION

Apparatuses, methods and storage medium associated with the placement of packets in one or more queues of a switch are described herein. In embodiments, the switch may include a plurality of virtual lane (VL) queues (VLQs) and a plurality of generic queues (GQs). A queue manager may be configured to selectively place a packet in a particular VL in a corresponding VLQ or a GQ. As used herein, the term “in a VL” or “within a VL” may refer to a configuration wherein a packet is using resources of one VL, out of one or more available VLs, to travel through a switch. In that case, the VL may be referred to as the “VL of the packet” or “the packet's VL.” Other variations on the above described phrases may be used and understood to generally correspond to the grammatical concept described.

In some embodiments, the packets may be adaptive or deterministic packets, as described below. In some embodiments, the switch may include 10 VLQs and 7 GQs. In some embodiments, the packet may be placed in a VLQ or a GQ based on the output port that the packet is destined for. In some embodiments, if the packet is placed in a GQ, the GQ may be allocated for the VL that the packet is in and the destined output port of the packet.

In the following detailed description, reference is made to the accompanying drawings which form a part hereof wherein like numerals designate like parts throughout, and in which is shown by way of illustration embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

Aspects of the disclosure are disclosed in the accompanying description. Alternate embodiments of the present disclosure and their equivalents may be devised without parting from the spirit or scope of the present disclosure. It should be noted that like elements disclosed below are indicated by like reference numbers in the drawings.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C).

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

As used herein, the terms “module” or “circuitry” may refer to, be part of, or include an Application Specific Integrated Circuit (ASIC), an electronic circuit, a processor (shared, dedicated, or group), and/or memory (shared, dedicated, or group) that execute one or more software or firmware programs, a combinational logic circuit, and/or other suitable hardware components that provide the described functionality. In some embodiments, the electronic device circuitry may be implemented in, or functions associated with the circuitry may be implemented by, one or more software or firmware modules.

In a tile-matrix switch, ports may be arranged in rows and columns. Specifically, at an input port, data packets destined to a congested column located at the front of a queue may block packets at the back of the queue, even though the blocked packets are destined to non-congested columns. In embodiments described below, the term “output ports” may be used generically to refer to columns, column queues, virtual column queues (VCQs), output ports of the switch, output queues of the switch, or any intermediate queuing points within the switch. The situation wherein a data packet in a queue destined to a specific output port may be blocking other data packets in the queue may be referred to as head-of-line (HOL) blocking.

Separate queues may be required for VLs of the switch. In general, a VL may refer to a specific route through a switch that has independent or dedicated resources. To put it another way, a VL may support multiple logical channels on the same physical link. VLs may provide a mechanism to avoid HOL blocking and support a quality of service (QoS). In embodiments, a VL may have independent or dedicated resources so that if one virtual lane queue (VLQ) associated with a specific VL becomes clogged or blocked, data packets in another VL are not affected. Generally, data packets in a VL may be stored or buffered in a VLQ.

To prevent HOL blocking, VCQs may be used. Specifically, packets destined to different columns or output ports may be stored in separate VCQs. VCQs may be similar to more common virtual output queues (VOQs). Generally, each input port or input queue may have a sub-queue for each VL, to allow packets in each VL to progress regardless of congestion encountered by packets in other VLs. Specifically, VOQs may describe a configuration wherein each input port or input queue has a sub-queue within each VL sub-queue for each output port. These sub-queues may be required for data packets destined for each output port, to avoid HOL blocking.

Large radix switches, e.g. switches with a large number of input/output ports, may include a relatively large number of VLs. In these large radix switches, it may be impractical to implement the number of queues and/or sub-queues required to support VCQs or VOQs as described above. Specifically, if there are a large number of input/output ports, as well as a large number of VLs, then the switch may include a large number of VCQs or VOQs for each VL. This relatively large number of queues and/or sub-queues may become prohibitively large in terms of both physical space and management resource requirements.

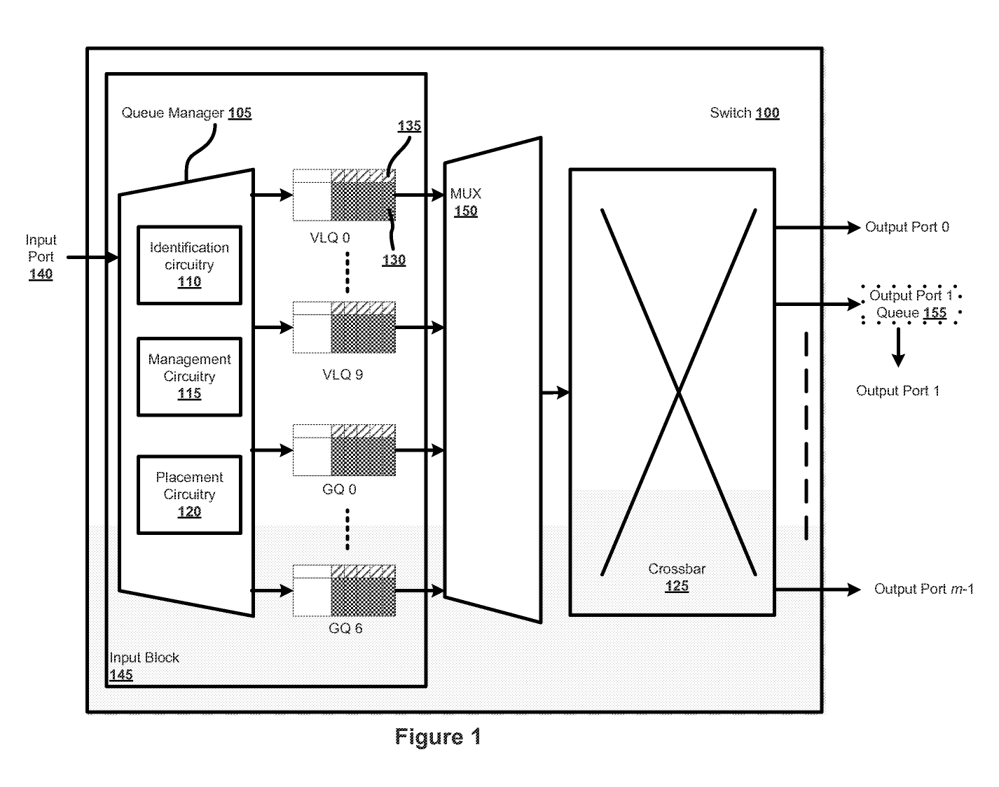

Embodiments of this disclosure may relate to the use of one or more dynamically assigned GQs that may provide benefits traditionally associated with VCQs, while reducing the number of queues in the switch. FIG. 1 may depict a switch 100 with one or more VLQs and one or more GQs, as described above. Specifically, as shown in FIG. 1, the switch 100 may have a total of 10 VLQs ranging from VLQ 0 to VLQ 9 (collectively referred to herein as “the VLQs”). In addition, the switch 100 may have a total of 7 GQs ranging from GQ 0 to GQ 6 (collectively referred to herein as “the GQs”).

The switch 100 may also include a plurality of input ports, though only a single input port 140 is depicted in FIG. 1 as an example. A queue manager 105 may be positioned between the input port 140 and the VLQs or GQs. In embodiments, the queue manager 105 may include identification circuitry 110, management circuitry 115, and/or placement circuitry 120. The queue manager 105 may be configured to act as a multiplexer and place data packets received on the input port 140 in one or more of the VLQs or GQs.

In other embodiments, the queue manager may be separate from, but communicatively coupled to, a multiplexer configured to place data packets received from the input port 140 into one or more of the VLQs or GQs. As used herein, “communicatively coupled” may indicate that two elements may communicate with one another either directly or through intervening logical blocks or circuits. In these embodiments, one or more of the identification circuitry 110, management circuitry 115, and/or placement circuitry 120 may be an element of the multiplexer and/or an element of the separate queue manager. In embodiments, the identification circuitry 110 may be configured to identify a first packet in a VL of a plurality of VLs and destined for an output port. The management circuitry 115 may be configured to identify whether a VL queue (VLQ) associated with the VL is empty. The placement circuitry 120 may be configured to place the first data packet in the VLQ if the VLQ is empty. The placement circuitry 120 may be further configured to place the first data packet in a generic queue (GQ) of a plurality of GQs if the VLQ is not empty. In some embodiments, one or more of the identification circuitry 110, management circuitry 115, and/or placement circuitry 120 may be combined into a single circuitry, while in other embodiments one or more of the identification circuitry 110, management circuitry 115, and/or placement circuitry 120 may be further sub-divided into separate circuitry units in or coupled with the switch 100 and/or management queue 105.

In embodiments, the queue manager 105, the VLQs, and the GQs may be an input block 145. Specifically, as shown in FIG. 1, input block 145 may be associated with input port 140. In embodiments where the switch 100 may include a plurality of input ports, the switch 100 may further include a plurality of input blocks such as input block 145 wherein a respective input block of the plurality of input blocks is associated with a respective input port of the plurality of input ports of the switch 100.

The switch 100 may further include one or more output ports. As shown in FIG. 1, the switch 100 may include m output ports from output port 0 to output port m−1 (collectively referred to herein as “the m output ports”). As described above, an output port may refer to a column, a column queue, a VCQ, an output port of the switch 100, an output queue of the switch 100, or any intermediate queuing points within the switch 100. For the sake of completeness, and without loss of generality, a distinct output port queue 155 related to output port 1 is depicted in FIG. 1. In embodiments, the other output ports may include or be an output port queue such as output port queue 155, as described above. A crossbar 125 may couple the input block 145 to the m output ports so that one or more data packets may be transferred from the input block 145 to one of the m output ports. In embodiments, a multiplexer (“MUX”) 150 may be positioned between the input block 145 and the crossbar 125. In embodiments, the MUX 150 may be configured to receive one or more packets from the VLQs or GQs of the input block 145 and transmit the packets to an input of the crossbar 125.

It will be understood that the specific labeling of the n output ports, the m output ports, the VLQs, or the GQs (e.g. input port 0, output port 1, VLQ 0, VLQ 9, etc.) is arbitrary and in embodiments the input ports, output ports, GQs or VLQs may be labeled according to a different syntax such as “1-10,” “A-J,” etc. In addition, although 10 VLQs and 7 GQs are shown, in other embodiments the switch 100 may include more or less VLQs or GQs. For example, in some embodiments the switch 100 may include 16 VLQs and 8 GQs. In other embodiments, the switch may include no VLQs, as will be described below.

In embodiments, each VLQ and GQ may be configured to hold one or more data packets. With specific reference to VLQ 0 of FIG. 1, VLQ 0 may be configured to hold a data packet 130 with a packet header 135. The data packet 130 may include a data payload, while the packet header 135 may include information related to a VL of the data packet 130, a destined output port of the data packet 130, or other information. In some embodiments, the VLQs and GQs may be broken into flits, which may be a fixed-size unit of the queues. A data packet such as data packet 130 and/or the packet header 135 may be stored in the VLQ or the GQ as one or more flits.

As noted above, a VLQ may be associated with a specific VL of the switch 100. A GQ may not be associated with a particular VL or output port of the switch 100. Therefore, the VLQs may be used to guarantee that each VL of the switch 100 has its own queue that can be used to maintain deadlock-free routing. The additional GQs may be used for separating traffic to different output ports in a manner similar to the VCQ process described above. In embodiments, each of the GQs may be dynamically allocated, and may be used to enqueue data packets of a particular VL destined for a particular output port.

As will be described in further detail below, a variety of allocation/deallocation policies of the GQs may be used to further optimize performance of the switch 100. In addition, the level of generality can also be adjusted with the GQs to further tradeoff between performance and complexity. For example, in the relatively restricted embodiment described above, a GQ may only support or be allocated for a single output port and a single VL. In a more general embodiment, a GQ may be able to support or be allocated for multiple output ports and a single VL. In an extreme unrestricted embodiment, the switch 100 may include no VLQs, and all of the queues of the switch 100 may be GQs.

In some embodiments, the queuing policy for placing data packets in a VLQ or a GQ may be different for deterministic packets than it is for adaptive packets. As used herein, a deterministic packet may be a data packet that is routed according to a deterministic routing protocol. Specifically, for deterministic traffic, the data packet may be routed through an intermediate node of the switch 100 that may be effectively selected by an entropy field in the packet header 135. An adaptive packet may be a data packet that is routed according to an adaptive routing protocol. Specifically, the data packet may be progressively routed either minimally to a destination and/or output port, or non-minimally to a randomly chosen intermediate node of the switch, and then minimally from there to the destination node or output port. The adaptive choice may be made by the queue manager 105 based on a local view of congestion of the switch 100 or a network to which the switch 100 may be coupled. In general, the queuing policy may be different for deterministic and adaptive packets. Specifically, it may be beneficial to deliver deterministic packets to a specific destination in order, a process referred to herein as “ordering.” Therefore, it may be beneficial to ensure that packets of the same VL and destined for the same output port all use the same queue. By contrast, adaptive packets may not be subject to an ordering requirement, and so they may be placed in any queue that is available for the VL of the adaptive packets without regard to the destined output port(s) of the adaptive packet.

For a deterministic data packet of a particular VL, a unicast routing table (URT) lookup may have already been performed by the queue manager 105, and the destined output port for the packet may have already been identified. Based on the output port, the queue manager 105 may identify whether to place the packet in a VLQ or a GQ.

Each of the GQs may be associated with or allocated for a particular VL and/or a particular output port. Once a GQ is allocated for a VL and output port, incoming data packets of that particular VL and destined for that output port may be placed into the allocated GQ to maintain proper ordering. When one or more of the data packets in the allocated GQ are sent, for example via the crossbar 125 to the destined output port of the data packet, the GQ may be deallocated and available for allocation for a different VL/output port pair. In some embodiments, a GQ may not be able to be deallocated until all packets from the GQ are transmitted. As noted above, in some less restrictive embodiments a GQ may be able to be allocated for a VL and a plurality of output ports.

In some embodiments, a VLQ may be able to service packets targeting all output ports for that VL. In some embodiments, each VLQ may include or contain output port counters that may be used to keep track of the number of deterministic packets that are currently inside the VLQ. In some embodiments, the output port counters may be used to identify whether a VLQ is holding one or more data packets destined for a specific output port. Specifically, each of the output port counters may be associated with a respective output port of the m output ports of the switch 100, and each of the output port counters may indicate the number of packets in the VLQ that are destined for a respective one of the output ports. The output port counters may be useful because if a GQ is allocated for a particular output port and a particular VL, it may be desirable for the VLQ to not also be holding deterministic packets for that output port for the sake of proper ordering.

At a high level, the queueing policy for an incoming deterministic packet of VLx destined to output port m (referred to as column m or Colm herein) may be as follows:

1) If VLQx (e.g., the VLQ associated with VLx) currently holds other deterministic packets destined for column m, then the incoming packet may be placed into VLQx. The Colm counter, that is the output port counter of VLQx that tracks the number of packets in VLQx destined for Colm, may be incremented, for example by the value of “1.”

2) If there is a GQ currently allocated for the VLx/Colm pair, the deterministic packet may be placed into the currently allocated GQ.

3) If (1) and (2) are not true and a GQ is available, the GQ is allocated for the VLx/Colm pair.

For an adaptive packet, ordering may not be required and the packet may go either into any VLQ or a GQ that is allocated for the VL. In some embodiments, whether the adaptive packet is placed into a VLQ or a GQ may be determined based on which queue has the least number of flits in it. In some embodiments, an adaptive packet placed into a VLQ may not cause an output port counter of the VLQ to increment. However, in some embodiment a counter related to adaptive packets in a GQ may be used. Specifically, the counter related to the adaptive packets may be used to identify when the GQ contains only adaptive packets, in which case an incoming deterministic packet of the VL that is destined to any output port may be placed in the GQ.

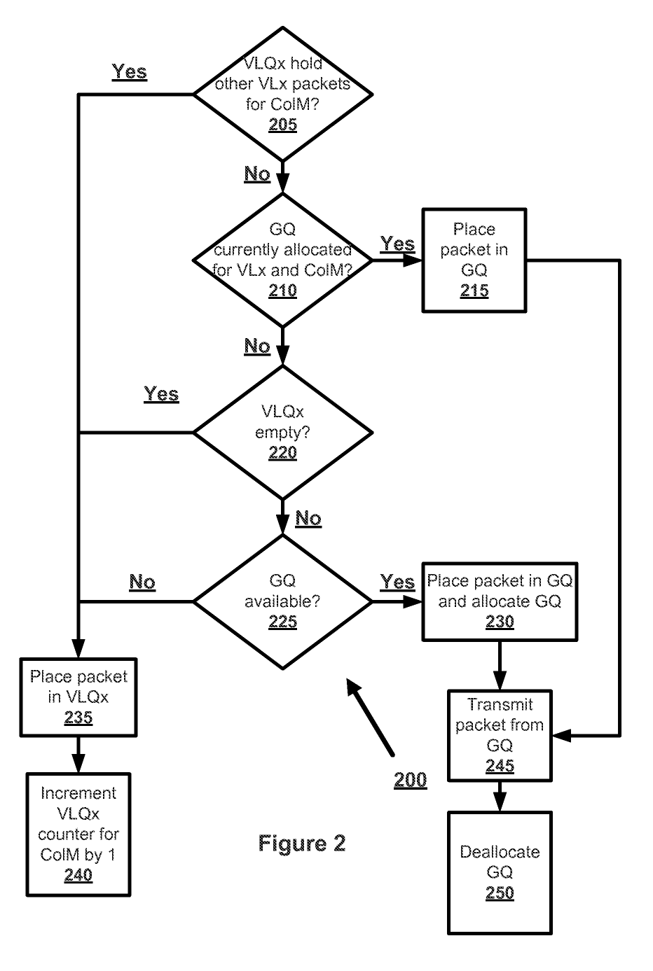

FIG. 2 depicts an example process 200 that may be used by a queue manager such as queue manager 105 for placing a data packet such as a deterministic data packet in a VLQ or a GQ, in accordance with various embodiments. Specifically, the process 200 may be related to incoming deterministic packet of VLx destined to output port m. As described above, at any given time, a GQ that is allocated may serve a particular VL and a particular output port, as described above. Once a GQ is allocated for a VL/output port pair, incoming packets of that VL and that are destined for that output port may all be placed into that GQ to maintain proper ordering of the deterministic packets. When all the packets in the GQ are sent, the GQ may be deallocated and available to be allocated for a different VL/output port pair.

Initially, the queue manager 105, and specifically the management circuitry 115 of the queue manager 105, may identify whether VLQx, the VLQ associated with VLx, holds other deterministic VLx packets destined for colm at 205. If VLQx does hold other VLx packets destined for colm, then the queue manager 105, and particularly the placement circuitry 120 of the queue manager 105, may place the packet in VLQx at 235. The queue manager 105, and particularly the placement circuitry 120 of the queue manager 105, may then increment a VLQx counter associated with colm by 1 at 240.

If the queue manager 105 identifies at 205 that VLQx does not hold other VLx packets destined for colm at 205, then the queue manager 105, and particularly the management circuitry 115, may then identify whether a GQ is currently allocated for the VLx/colm pair at 210. If a GQ is allocated for the VLx/colm pair, then the queue manager 105, and particularly the placement circuitry 120, may place the packet in the identified GQ at 215. In embodiments, the queue manager 105 may then transmit the packet from the GQ at 245 and deallocate the GQ at 250, as described above. As noted above, in embodiments it may not be possible to deallocate the GQ at 250 until all of the packets in the GQ have been transmitted.

If the queue manager 105 identifies that there is not another GQ currently allocated for the VLx/colm pair at 210, the queue manager 105, and particularly the management circuitry 115, may identify at 220 whether VLQx is empty. If VLQx is empty, the queue manager 105, and particularly the placement circuitry 120, may place the packet in VLQx at 235 and increment a VLQx counter at 240 as described above.

If the queue manager 105 identifies at 220 that VLQx is not empty, then the queue manager 105, and particularly the management circuitry 115, may identify at 225 whether a GQ is available. If the GQ is not available, then the queue manager 105, and particularly the placement circuitry 120 of the queue manager 105, may place the packet in VLQx at 235 and increment a VLQx counter at 240, as described above. If a GQ is available, then the queue manager 105, and particularly the placement circuitry 120 of the queue manager 105, may place the packet in the GQ and allocate the GQ for the VLx/colm pair at 230. The queue manager may then transmit the packet from the GQ at 245 and deallocate the GQ at 250 as described above.

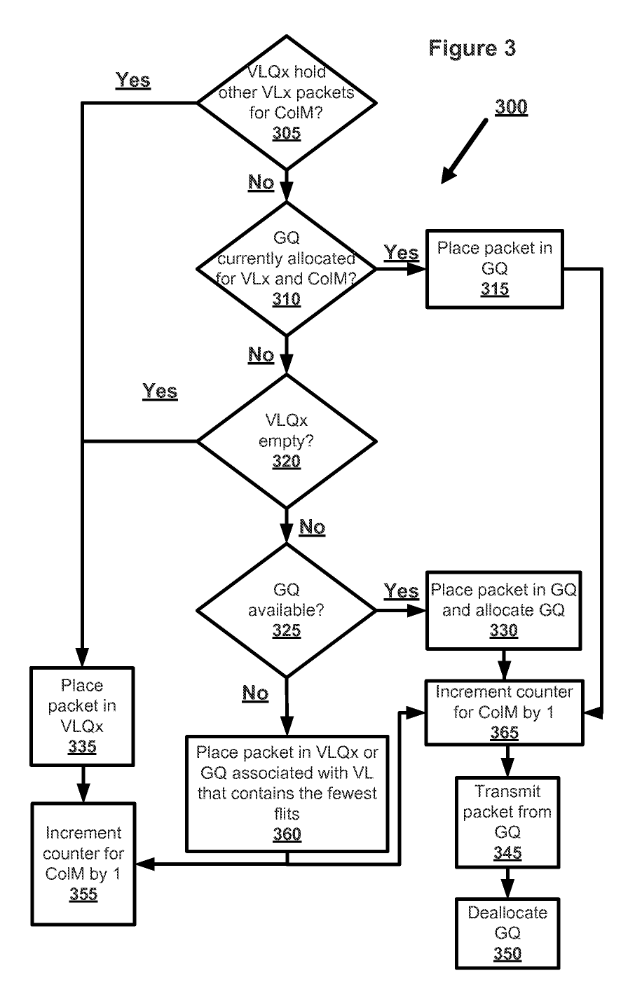

In some embodiments, multiple output ports may share a GQ in a manner similar to the manner in which multiple output ports may share a VLQ. That is, a GQ may be allocated for a VLx and multiple output ports. In this embodiments, the GQ may include one or more counters for each output port, which may be similar to the output port counters described above for the VLQs. The output port counters of the GQ may be used to track the number of packets in the GQ for a given output port. In some embodiments, it may not be possible to represent an output port in both a VLQ and a GQ, so it may not be necessary to double or even increase the number of output port counters that are used just by the VLQs as described above. Rather, it may be sufficient to simply track whether a given output port counter is being used for a VLQ or a GQ. FIG. 3 illustrates a process 300 that may be used by a queue manager such as queue manager 105 for placing a data packet in a VLQ or a GQ, in accordance with the embodiment described above wherein multiple output ports may share a GQ. Specifically, the process 300 may be related to incoming deterministic packet of VLx destined to output port m (referred to as column m or Colm herein). Elements of process 300 may be similar to similarly numbered elements of process 200, and so certain details such as the specific actor of queue manager 105 or other details may be omitted for the sake of clarity and brevity.

Initially, the queue manager 105 may identify whether VLQx holds other deterministic VLx packets destined for colm at 305. If VLQx does hold other VLx packets destined for colm, then the queue manager 105 may place the packet in VLQx at 335. The queue manager 105 may then increment a counter associated with colm by 1 at 355. In embodiments, the counter may be a counter of the VLQx, while in other embodiments the counter may be an output port counter that could be associated with either or both of the VLQx or a GQ as described above.

If the queue manager 105 identifies at 305 that VLQx does not hold other VLx packets destined for colm at 305, then the queue manager 105 may then identify whether a GQ is currently allocated for the VLx/colm pair at 310. If a GQ is allocated for the VLx/colm pair, then the queue manager 105 may place the packet in the identified GQ at 315. The queue manager 105, and specifically the placement circuitry 120 of the queue manager, may then increment a counter for colm at 365 as described above. In some embodiments, the counter may be a counter of the GQ, while in other embodiments the counter may be an output port counter that may be associated with either or both of the VLQx or a GQ as described above. In embodiments, the queue manager 105 may then transmit the packet from the GQ at 345 and deallocate the GQ at 350, as described above. In embodiments, as described above, it may not be possible to deallocate the GQ at 350 until all of the packets in the GQ have been transmitted.

If the queue manager 105 identifies that there is not another GQ currently allocated for the VLx/colm pair at 310, the queue manager 105 may identify at 320 whether VLQx is empty. If VLQx is empty, the queue manager 105 may optionally place the packet in VLQx at 335 and increment a counter at 355 as described above.

If the queue manager 105 identifies at 320 that VLQx is not empty, then the queue manager 105 may identify at 325 whether a GQ is available. If a GQ is available, then the queue manager 105 may place the packet in the GQ and allocate the GQ for the VLx/colm pair at 330. The queue manager 105 may then increment a counter at 365, transmit the packet from the GQ at 345 and deallocate the GQ at 350, as described above.

If the queue manager 105, and particularly the management circuitry 115 identifies that a GQ is not available at 325, then the queue manager 105, and particularly the placement circuitry 120, may place the packet in VLQx or GQ associated with VLx at 360. In embodiments, whether the packet is placed in VLQx or a GQ associated with VLx at 360 may be based on the number of flits in the VLQx or the GQ. Specifically, the packet may be placed into whichever of the VLQx or the GQ has the fewest flits. The queue manager 105 may then increment the counter of colm at 355 or 365, dependent on whether the packet was placed into VLQx or the GQ, respectively. If the packet is placed into the GQ, the queue manager may then transmit the packet from the GQ at 345 and deallocate the GQ at 350, as described above.

As depicted above with respect to element 360 of FIG. 3, the process 300 may choose between available queues (VLQx or GQ) based on queue occupancy, that is the number of flits in the queue. In other embodiments, the VLQx or GQ may be selected based on queue congestion. In some embodiments, queue occupancy may be an indirect measurement of queue congestion, while in other embodiments queue congestion may be measured directly. In addition, when there are packets for more than one output port present in a queue, it may be desirable to identify which output port is the source of the congestion and isolate packets for that output port in the queue. In other words, it may be desirable to move future packets for other uncongested output ports into different queues, so that the congested output ports do not impact the flow of packets to uncongested output ports.

When a deterministic packet arrives at the head of a queue, the queue manager may perform a credit check to determine whether there is queue space available at the appropriate output port queue to start moving the packet. If credits are not available, the path may be considered to be congested. The queue manager may use a timer to measure the amount of time the packet waits at the head of the queue before credits are available to move the packet. Once credits are available, the queue manager may average the measured wait time with the wait time of previous packets for that output port to maintain a trailing average head of queue wait time for the output port.

Packets for output ports already in a congested queue may continue to be placed in the congested queue, even when they are not the source of the congestion. If the output port counter reaches zero, the next arrival of a packet associated with that output port may be placed in a less congested queue. For long-lived congestion, over time the algorithm may tend to move other packets associated with other output ports out of the congested queue and isolate the congested output port in the queue.

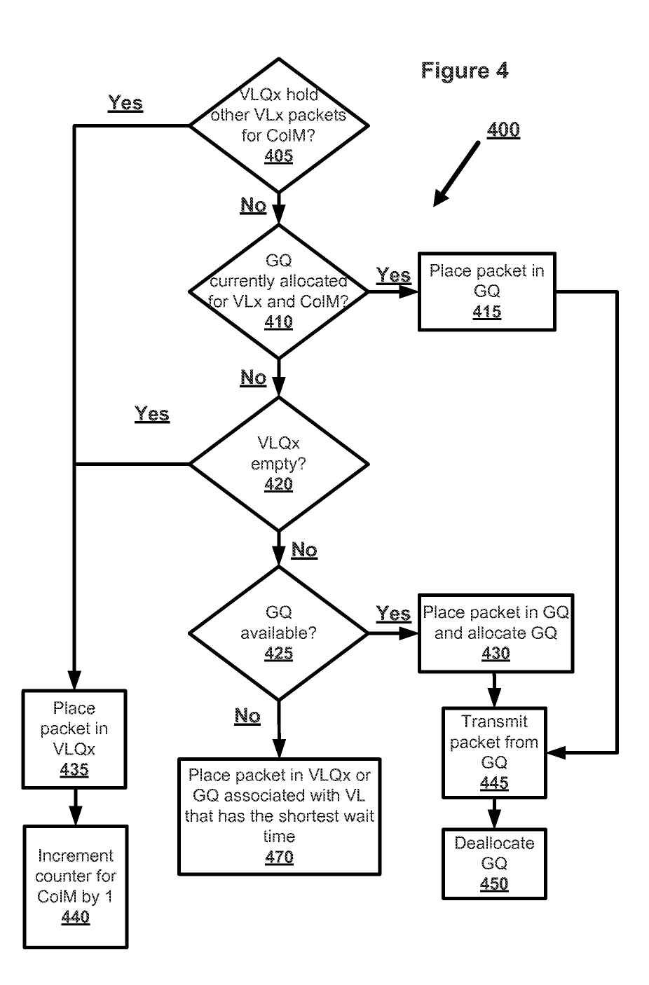

FIG. 4 illustrates an alternative process 400 that may be used by a queue manager such as queue manager 105 for placing a data packet in a VLQ or a GQ, in accordance with various embodiments. Elements of process 400 may be similar to similarly numbered elements of processes 200 or 300, and so certain details such as the specific actor of queue manager 105 or other details may be omitted for the sake of clarity and brevity.

Initially, the queue manager 105 may identify whether VLQx holds other deterministic VLx packets destined for colm at 405. If VLQx does hold other VLx packets destined for colm, then the queue manager 105 may place the packet in VLQx at 435. The queue manager 105 may then increment a counter associated with colm by 1 at 440 in a manner similar to incrementing the counter associated with colm at 240 as described above.

If the queue manager 105 identifies at 405 that VLQx does not hold other VLx packets destined for colm at 405, then the queue manager 105 may then identify whether a GQ is currently allocated for the VLx/colm pair at 410. If a GQ is allocated for the VLx/colm pair, then the queue manager 105 may place the packet in the identified GQ at 415. In embodiments, the queue manager 105 may then transmit the packet from the GQ at 445 and deallocate the GQ at 450, as described above. As described above, in some embodiments the GQ may not be deallocated at 450 until all of the packets in the GQ have been transmitted.

If the queue manager 105 identifies that there is not another GQ currently allocated for the VLx/colm pair at 410, the queue manager 105 may identify at 420 whether VLQx is empty. If VLQx is empty, the queue manager 105 may place the packet in VLQx at 435 and increment a counter at 455 as described above.

If the queue manager 105 identifies at 420 that VLQx is not empty, then the queue manager 105 may identify at 425 whether a GQ is available. If a GQ is available, then the queue manager 105 may place the packet in the GQ and allocate the GQ for the VLx/colm pair at 430. The queue manager 105 may then transmit the packet from the GQ at 445 and deallocate the GQ at 450, as described above.

If the queue manager 105 identifies that a GQ is not available at 425, then the queue manager 105, and particularly the placement circuitry 420, may place the packet in VLQx or GQ associated with VLx at 470. In embodiments, whether the packet is placed in VLQx or a GQ associated with VLx at 470 may be based on whether the VLQx or the GQ has the shortest wait time, as discussed above.

Although certain processes 200, 300, and 400 are depicted above for the placement of deterministic packets, in certain embodiments similar processes, or elements of the processes 200, 300, and 400, may be performed for adaptive packets. In some embodiments, certain of the processes may be combined, for example the GQ counter described with respect to process 300 may be used in process 400. In some embodiments, certain elements of processes may be switched or performed in a different order than the order depicted in FIG. 2, 3, or 4. For example, in some embodiments element 210 may be performed prior to element 205. In some embodiments certain additional steps may be performed to what is shown in the various FIG. 2, 3, or 4. For example, in some embodiments if the packet is placed in VLQx at 470, then the counter may be incremented at 440. Other variations or adaptations of the depicted processes may be possible, though they are not specifically enumerated or described herein. In some embodiments, the determination of whether a GQ is available at, for example, 225, 325, or 425 (and the associated steps that result from the decision at 225, 325, or 425) may be performed prior to the determination of whether VLQx is empty at, for example 220, 320, or 420.

In some embodiments of switch 100, there may not be any separation of VLQs and GQs. Rather, all of the queues may be treated as a single type, e.g. GQs. To ensure traffic separation, the queue manager 105 may ensure that there is always at least one queue available for each VL, but there may not be any specific queue dedicated to each VL. This embodiment may co-exist with alterations of any of processes 200, 300, or 400. The alterations may include altering processes 200, 300, or 400 such that if VLQx becomes empty, if there are one or more GQs currently associated with or allocated for VLx, that GQ may be named the VLQx, and the previous VLQx may become a GQ. If there are no GQs associated with or allocated for VLx, VLQx may remain a VLQ.

As discussed above, in embodiments the processes 200, 300, or 400 may be more suited to deterministic packets. Specifically, when the data packet is an adaptive packet, ordering may not be necessary, and the adaptive packet associated with VLx may be placed into either VLQx or one of the GQs that are, or could be, allocated for VLx, whichever one is identified as being the “best”. How “best” is measured may depend on which deterministic algorithm is used, and what hardware exists to measure queue quality. For example, a determination of “best” may be based on identification of which VLQ or GQ has the fewest flits in the queue, or the determination of “best” may be based on an aspect of wait time of the queue such as trailing average wait time.

In some embodiments, it may be useful to track the number of adaptive packets in each GQ so that when the GQ has nothing but adaptive packets in it, new deterministic traffic of the same VL can consider the queue as a possible allocation choice. In some embodiments it may be desirable to place an adaptive packet into the queue that is identified as being the least likely to block.

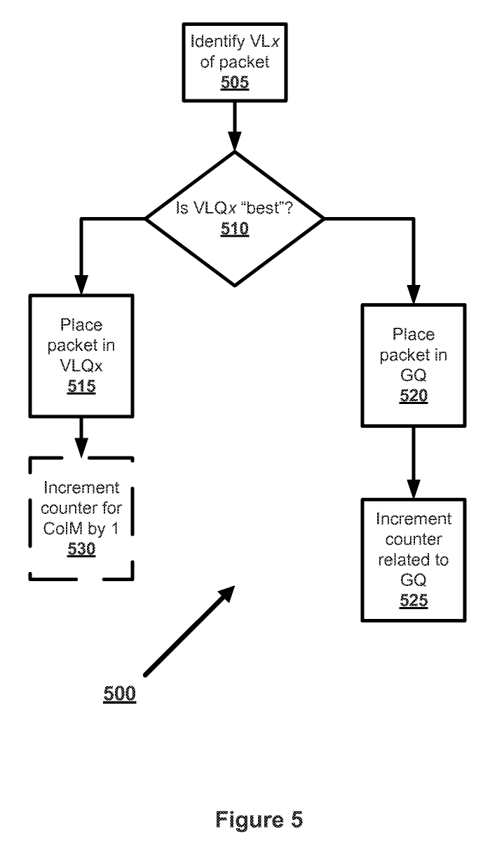

FIG. 5 illustrates an alternative process 500 that may be used by a queue manager such as queue manager 105 for placing a data packet such as an adaptive data packet in a VLQ or a GQ, in accordance with various embodiments. In embodiments, the queue manager 105, and specifically the identification circuitry 110 of the queue manager 105, may identify VLx, e.g. which VL the packet is associated with or destined for. The queue manager 105, and specifically the management circuitry 115, may then identify whether VLQx is “best” at 510. For example, the management circuitry 115 may identify whether the VLQx is best based on one or more of the factors described above. If the VLQx is identified as being best at 510, then the queue manager 105, and specifically the placement circuitry 120 may place the packet in VLQx at 515. In some embodiments, the queue manager 105 may optionally increment one or more counters of VLQx associated with the destined output port of the adaptive packet at 530, e.g. colm as described above.

If the queue manager 105 identifies at 510 that VLQx is not “best,” then the queue manager 105, and specifically the placement circuitry 120, may place the packet in a GQ at 520. In embodiments, the queue manager 105, and specifically the placement circuitry 120, may further increment a counter related to the number of adaptive packets in the GQ at 525, as described above.

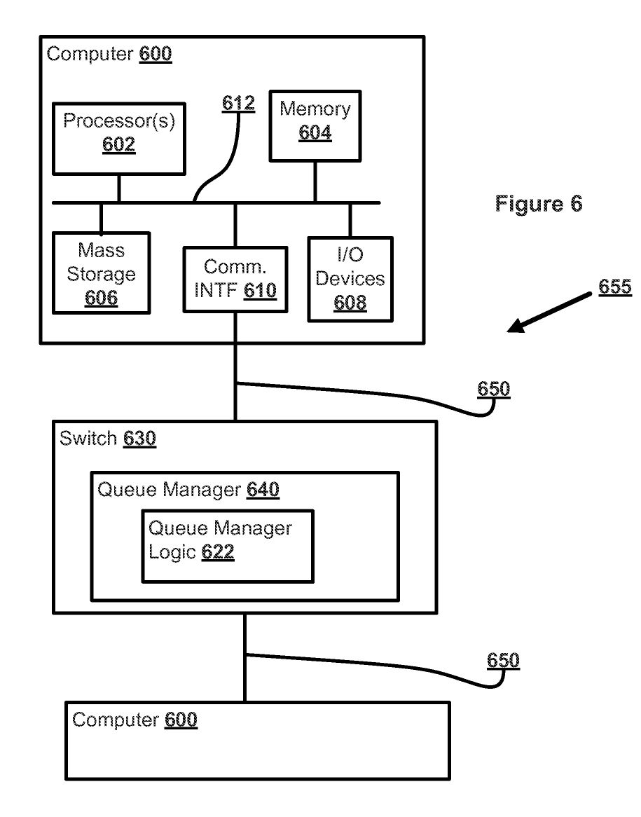

FIG. 6 illustrates an example computer system 655 incorporating a switch such as switch 100. In embodiments, the computer system 655 may be suitable to practice selected aspects of the present disclosure. As shown, the computer system 655 may include a plurality of computers 600 coupled with a switch 630, which may be similar to switch 100 of FIG. 1. Although FIG. 6 depicts two computers 600, only components of one of the computers 600 is depicted for the sake of conciseness. In embodiments, both of the computers 600 of the computer system 655 may include the same number or types of components, while in other embodiments the computers 600 may include components that are different than one another. Additionally, although only two computers 600 are depicted, in other embodiments the computer system 655 may include a plurality of computers 600.

Computer 600 may include one or more processors or processor cores 602, and system memory 604. For the purpose of this application, including the claims, the terms “processor” and “processor cores” may be considered synonymous, unless the context clearly requires otherwise. Additionally, computer 600 may include mass storage devices 606 (such as diskette, hard drive, compact disc read only memory (CD-ROM) and so forth), input/output devices 608 (such as display, keyboard, cursor control and so forth) and communication interfaces 610 (such as network interface cards, modems and so forth). The elements may be coupled to each other via system bus 612, which may represent one or more buses. In the case of multiple buses, they may be bridged by one or more bus bridges (not shown).

Each of these elements may perform its conventional functions known in the art. In particular, system memory 604 and mass storage devices 606 may be employed to store a working copy and a permanent copy of programming instructions implementing the operations associated with one or more processes. The various elements may be implemented by assembler instructions supported by processor(s) 602 or high-level languages, such as, for example, C, that can be compiled into such instructions.

The number, capability and/or capacity of these elements 610-612 may vary, depending on whether computer 600 is used as a mobile device, a stationary device or a server. When use as mobile device, the capability and/or capacity of these elements 610-612 may vary, depending on whether the mobile device is a smartphone, a computing tablet, an ultrabook or a laptop. Otherwise, the constitutions of elements 610-612 are known, and accordingly will not be further described.

In some embodiments, the computers 600, and particularly the communication interfaces 610 of the computers, may be coupled with the switch 630 via an external bus 650. In embodiments, the external bus may be a peripheral component interconnect express (PCIe) bus, a system management bus (SMBus), or some other type of bus.

The switch 630 may include a queue manager 640, which may be similar to queue manager 105 of FIG. 1. In some embodiments, the queue manager 640 may include queue manager logic 622. The queue manager logic 622 may be hardware, firmware, or software configured to perform or execute one or more processes such as processes 200, 300, 400, or 500. In some embodiments, the switch 630, and particularly the queue manager, may include one or more processors, memory, and/or mass storage as described above with respect to computer 600 but not explicitly shown in FIG. 6 for the sake of clarity. In some embodiments, the one or more processors, memory, and/or mass storage may be contain computer-executable instructions configured to cause the switch 630, and particularly the queue manager 640 and/or the queue manager logic 622 to execute or perform one or more elements of the processes 200, 300, 400, or 500.

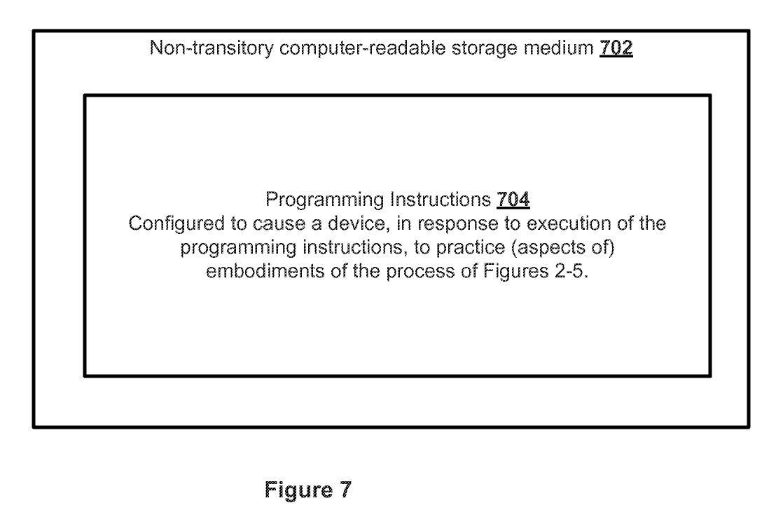

Specifically, as will be appreciated by one skilled in the art, the present disclosure may be embodied as methods or computer program products. Accordingly, the present disclosure, in addition to being embodied in hardware as earlier described, may take the form of an entirely software embodiment (including firmware, resident software, micro-code, etc.) or an embodiment combining software and hardware aspects that may all generally be referred to as a “circuit,” “module” or “system.” Furthermore, the present disclosure may take the form of a computer program product embodied in any tangible or non-transitory medium of expression having computer-usable program code embodied in the medium. FIG. 7 illustrates an example computer-readable non-transitory storage medium that may be suitable for use to store instructions that cause an apparatus, in response to execution of the instructions by the apparatus, to practice selected aspects of the present disclosure. As shown, non-transitory computer-readable storage medium 702 may include a number of programming instructions 704. Programming instructions 704 may be configured to enable a device, e.g., switch 100/630, in response to execution of the programming instructions by a processor of switch 100/630, to perform processes such as 200, 300, 400, or 500. In alternate embodiments, programming instructions 704 may be disposed on multiple computer-readable non-transitory storage media 702 instead. In alternate embodiments, programming instructions 704 may be disposed on computer-readable transitory storage media 702, such as, signals.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present disclosure is described with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a,” “an” and “the” are intended to include plural forms as well, unless the context clearly indicates otherwise. It will be further understood that the terms “comprises” and/or “comprising,” when used in this specification, specific the presence of stated features, integers, steps, operations, elements, and/or components, but do not preclude the presence or addition of one or more other features, integers, steps, operation, elements, components, and/or groups thereof.

Embodiments may be implemented as a computer process, a computing system or as an article of manufacture such as a computer program product of computer readable media. The computer program product may be a computer storage medium readable by a computer system and encoding a computer program instructions for executing a computer process.

The corresponding structures, material, acts, and equivalents of all means or steps plus function elements in the claims below are intended to include any structure, material or act for performing the function in combination with other claimed elements are specifically claimed. The description of the present disclosure has been presented for purposes of illustration and description, but is not intended to be exhaustive or limited to the disclosure in the form disclosed. Many modifications and variations will be apparent to those of ordinary skill without departing from the scope and spirit of the disclosure. The embodiment was chosen and described in order to best explain the principles of the disclosure and the practical application, and to enable others of ordinary skill in the art to understand the disclosure for embodiments with various modifications as are suited to the particular use contemplated.

Referring back to FIG. 6, for one embodiment, at least one of processors 602 may be packaged together with memory (in lieu of storing on memory 604 and storage 606). For one embodiment, at least one of processors 602 may be packaged together with memory to form a System in Package (SiP). For one embodiment, at least one of processors 602 may be integrated on the same die with memory. For one embodiment, at least one of processors 602 may be packaged together with memory to form a System on Chip (SoC). For at least one embodiment, the SoC may be utilized in, e.g., but not limited to, a smartphone or computing tablet.

In some embodiments the switch 630 may be a stand-alone component, while in other embodiments the switch 630 may be an element of a SoC or SiP that includes one or more processors coupled with the switch.

Thus various example embodiments of the present disclosure have been described including, but are not limited to:

Example 1 may include a switch comprising: a plurality of output ports; a plurality of virtual lane queues (VLQs) communicatively coupled with the output ports, and respectively associated with a plurality of virtual lanes (VLs); a plurality of generic queues (GQs) communicatively coupled with the output ports, and unassociated with any VL; and a queue manager communicatively coupled with the plurality of VLQs and the plurality of GQs, the queue manager to selectively place a packet of a VL and destined for an output port of the plurality of output ports in a corresponding VLQ of the plurality of VLQs or a GQ of the plurality of GQs.

Example 2 may include the switch of example 1, wherein the queue manager is to selectively place the packet in the GQ based on a condition of the corresponding VLQ.

Example 3 may include the switch of example 2, wherein the queue manager is further to allocate, in relation to a selective placement of the packet in the GQ, the GQ as associated with a VL of the plurality of VLs and the output port.

Example 4 may include the switch of example 3, wherein the queue manager is further to allocate, in relation to the selective placement of the packet in the GQ, the GQ as associated with the VL of the plurality of VLs and a subset of the plurality of output ports that includes the output port.

Example 5 may include the switch of any of examples 1-4, comprising 7 GQs.

Example 6 may include the switch of any of examples 1-4, comprising 10 VLQs.

Example 7 may include the switch of any of examples 1-4, further comprising a crossbar coupled with the plurality of GQs, the plurality of VLQs, and the plurality of output ports.

Example 8 may include the switch of any of examples 1-4, wherein the switch is an element of a system on chip (SoC) that includes the switch and one or more processors.

Example 9 may include the switch of any of examples 1-4, wherein the packet is a deterministic packet.

Example 10 may include the switch of example 9, wherein a header of the deterministic packet includes an indication of an intermediate node of the switch in an entropy field of the header.

Example 11 may include the switch of example 9, wherein the queue manager is to increment a counter associated with the VLQ based on a selective placement of the packet in the VLQ.

Example 12 may include the switch of example 11, wherein the VLQ is associated with 8 counters, wherein a respective counter of the 8 counters is associated with a respective output port of the plurality of output ports.

Example 13 may include the switch of example 12, wherein an output port of the plurality of output ports is a column of the switch.

Example 14 may include the switch of any of examples 1-4, wherein the packet is an adaptive packet.

Example 15 may include the switch of example 14, wherein the adaptive packet is to be progressively routed minimally to the output port, or non-minimally to a randomly chosen intermediate node of the switch and then minimally to the output port.

Example 16 may include the switch of example 14, wherein the queue manager is further to increment a counter related to the GQ based on a selective placement of the packet in the GQ.

Example 17 may include the switch of example 14, wherein the queue manager is to selectively place the packet in the GQ or the corresponding VLQ based on a wait time of the GQ and a wait time of the corresponding VLQ.

Example 18 may include the switch of example 14, wherein the queue manager is to selectively place the packet in the GQ or the corresponding VLQ based on a number of flits in the GQ and a number of flits in the corresponding VLQ.

Example 19 may include a queue manager in a switch, the queue manager comprising: identification circuitry to identify a first data packet as a data packet of a virtual lane (VL) of a plurality of VLs and an output port; management circuitry to identify whether a VL queue (VLQ) associated with the VL is empty; and placement circuitry to: place the first data packet in the VLQ if the VLQ is empty; and place the first data packet in a generic queue (GQ) of a plurality of GQs if the VLQ is not empty.

Example 20 may include the queue manager of example 19, wherein the placement circuitry is further to place the first data packet in the VLQ if the VLQ contains a second data packet that is destined for the same output port as the first data packet.

Example 21 may include the queue manager of example 19, wherein the plurality of VLQs includes 10 VLQs.

Example 22 may include the queue manager of example 19, wherein the plurality of GQs includes 7 GQs.

Example 23 may include the queue manager of example 19, wherein the placement circuitry is further to allocate, in relation to placement of the first data packet in the GQ, the GQ for the VL of the plurality of VLs and the destined output port of the first data packet.

Example 24 may include the queue manager of example 23, wherein the placement circuitry is further to allocate, in relation to placement of the first data packet in the GQ, the GQ for the VL of the plurality of VLs and a plurality of output ports that includes the destined output port of the first data packet.

Example 25 may include the queue manager of example 23, wherein the placement circuitry is further to deallocate, based on an indication of a transmission of the first data packet from the GQ to the destined output port of the first data packet, the GQ for the VL of the plurality of VLs and the destined output port of the first data packet.

Example 26 may include the queue manager of example 25, wherein the placement circuitry is further to deallocate, based on an indication of a transmission of all data packets from the GQ to the destined output port of the first data packet, the GQ for the VL of the plurality of VLs and the destined output port of the first data packet.

Example 27 may include the queue manager of example 25, wherein the placement circuitry is further to deallocate, based on an indication of a transmission of the first data packet and all other data packets in the GQ, the GQ for the VL of the plurality of VLs and the destined output port of the first data packet.

Example 28 may include the queue manager of any of examples 19-27, wherein the placement circuitry is further to increment, based on placement of the first data packet in the VLQ, a counter associated with the VLQ and the destined output port of the first data packet.

Example 29 may include the queue manager of any of examples 19-27, wherein the identification circuitry is further to identify the destined output port of the first data packet based on an indication of a column of the switch.

Example 30 may include the queue manager of any of examples 19-27, wherein the first data packet is a deterministic packet.

Example 31 may include the queue manager of example 30, wherein the header includes an indication of an intermediate node of the switch in an entropy field of the header.

Example 32 may include the queue manager of any of examples 19-27, wherein the first data packet is an adaptive packet.

Example 33 may include the queue manager of example 32, wherein the adaptive packet is to be progressively routed either minimally to the output port, or non-minimally to a randomly chosen intermediate node of the switch and then minimally to the output port.

Example 34 may include the queue manager of example 33, wherein the placement circuitry is further to increment a counter related to the GQ based on a selective placement of the first data packet in the GQ.

Example 35 may include one or more non-transitory computer-readable media comprising instructions to cause a queue manager of a switch, upon execution of the instructions by one or more processors of the switch, to: identify, based on a header of a first packet, a virtual lane (VL) of the first packet and an output port that is a destined output port of the first packet; identify whether a VL queue (VLQ) associated with the VL of the first packet is empty; place, if the VLQ is empty, the first packet in the VLQ; and place, if the VLQ is not empty, the first packet in a generic queue (GQ) of the switch.

Example 36 may include the one or more non-transitory computer-readable media of example 35, wherein the instructions are further to place the first data packet in the VLQ if the VLQ contains a second data packet that is destined for the same output port as the first data packet.

Example 37 may include the one or more non-transitory computer-readable media of example 35, wherein the instructions are further to allocate, in relation to a placement of the first packet in the GQ, the GQ for the VL of the first packet and the destined output port.

Example 38 may include the one or more non-transitory computer-readable media of example 37, wherein the instructions are further to allocate the GQ for the VL of the first packet and a plurality of output ports that includes the destined output port.

Example 39 may include the one or more non-transitory computer-readable media of example 37, wherein the instructions are further to deallocate, based on an indication of a transmission of the first packet from the GQ to the destined output port of the first packet, the GQ for the VL of the first packet and the destined output port of the first packet.

Example 40 may include the one or more non-transitory computer-readable media of example 39, wherein the instructions are further to deallocate the GQ after transmission of all packets from the GQ.

Example 41 may include the one or more non-transitory computer-readable media of any of examples 35-40, wherein the instructions are further to increment, based on a placement of the first packet in the VLQ, a counter associated with the VLQ and the destined output port of the first packet.

Example 42 may include the one or more non-transitory computer-readable media of any of examples 35-40, wherein the instructions are further to identify the destined output port of the first packet based on an indication of a column of the switch.

Example 43 may include the one or more non-transitory computer-readable media of any of examples 35-40, wherein the first packet is a deterministic packet.

Example 44 may include the one or more non-transitory computer-readable media of example 43, wherein the header includes an indication of an intermediate node of the switch in an entropy field of the header.

Example 45 may include the one or more non-transitory computer-readable media of any of example 35-40, wherein the first packet is an adaptive packet.

Example 46 may include the one or more non-transitory computer-readable media of example 45, wherein the adaptive packet is to be progressively routed either minimally to the destined output port of the first packet, or non-minimally to a randomly chosen intermediate node of the switch and then minimally to the destined output port of the first packet.

Example 47 may include the one or more non-transitory computer-readable media of example 46, further comprising instructions to increment a counter related to the GQ upon a selective placement of the first packet in the GQ.

Example 48 may include a method comprising: identifying, by a queue manager of a switch based on a header of a first packet, an indication of a virtual lane (VL) of the switch and an indication of an output port of the switch; identifying, by the queue manager, whether a VL queue (VLQ) associated with the VL contains a second packet; placing, by the queue manager if the VLQ contains the second packet destined for the identified output port, the first packet in the VLQ; and placing, by the queue manager if the VLQ contains the second packet destined for a different output port than the identified output port, the first packet in a generic queue (GQ) of the switch.

Example 49 may include the method of example 48, further comprising allocating, by the queue manager in relation to the placing of the first packet in the GQ, the GQ for the identified VL and the identified output port.

Example 50 may include the method of example 48, further comprising allocating, by the queue manager in relation to the placing of the first packet in the GQ, the GQ for the identified VL and a plurality of output ports of the switch, the plurality of output ports including the identified output port.

Example 51 may include the method of example 49, further comprising deallocating, by the queue manager based on an indication of a transmission of the first packet from the GQ to the identified output port, the GQ for the identified VL and the identified output port.

Example 52 may include the method of example 51, further comprising facilitating transmission, by the queue manager, of all packets currently in the GQ from the GQ; and deallocating, by the queue manager based on the transmission of all packets from the GQ, the GQ for the identified VL and the identified output port.

Example 53 may include the method of any of examples 48-52, further comprising incrementing, by the queue manager based on the placing of the first packet in the VLQ, a counter associated with the VLQ and the identified output port.

Example 54 may include the method of any of examples 48-52, further comprising identifying, by the queue manager, the identified output port of the packet based on an indication of a column of the switch in the header of the packet.

Example 55 may include the method of any of examples 48-52, wherein the first packet is a deterministic packet.

Example 56 may include the method of example 55, wherein the header includes an indication of an intermediate node of the switch in an entropy field of the header.

Example 57 may include the method of any of examples 48-52, wherein the first packet is an adaptive packet.

Example 58 may include the method of example 57, wherein the adaptive packet is to be progressively routed either minimally to the identified output port, or non-minimally to a randomly chosen intermediate node of the switch and then minimally to the identified output port.

Example 59 may include the method of example 58, further comprising incrementing, by the queue manager, a counter related to the GQ upon a selective placement of the first packet in the GQ.

Example 60 may include a switch comprising: a plurality of output ports; 10 virtual lane queues (VLQs) communicatively coupled with the plurality of output ports, respective VLQs associated with respective virtual lanes (VLs) of the switch; 7 generic queues (GQs) communicatively coupled with the plurality of output ports and unassociated with any VL; a crossbar coupled with the 7 GQs and the 10 VLQs and the plurality of output ports; and a queue manager communicatively coupled with plurality of VLQs and the plurality of GQs, the queue manager to: identify, based on an indication of a VL of the packet and an indication of an output port of the plurality of output ports in a header of the packet, the VL of the packet and a destined output port of the packet; selectively place a packet in a VLQ of the 10 VLQs that is associated with the VL of the packet or a GQ of the 7 GQs based on a condition of the VLQ; allocate, in relation to placement of the packet in the GQ, the GQ as associated with the VLQ and the destined output port; and increment, based on placement of the packet in the VLQ, a counter associated with the VLQ and the destined output port of the plurality of output ports.

Example 61 may include a method comprising: identifying, by a queue manager of a switch based on a header of a first packet, a virtual lane (VL) of the first packet and a destined output port of the first packet; identifying, by the queue manager, whether a VL queue (VLQ) of 10 VLQs that is associated with the VL of the first packet contains a second packet; selectively placing, by the queue manager if the VLQ does not contain a second packet, the first packet in the VLQ and incrementing a counter associated with the VLQ and the destined output port of the first packet; selectively placing, by the queue manager if the VLQ contains a second packet destined for the destined output port of the first packet, the first packet in the VLQ and incrementing a counter associated with the VLQ and the destined output port of the first packet; and selectively placing, by the queue manager if the VLQ contains a second packet destined for a different output port than the destined output port of the first packet, the first packet in a generic queue (GQ) of 7 possible GQs, allocating the GQ for the destined VL and the destined output port of the first packet, and deallocating, based on an indication of a transmission all packets from the GQ, the GQ for the destined VL and the destined output port of the first packet.

Example 62 may include a queue manager of a switch comprising: means to identify, based on a header of a first packet, a virtual lane (VL) of the first packet and a destined output port of the first packet; means to identify whether a VL queue (VLQ) of 10 VLQs that is associated with the VL of the first packet contains a second packet; means to selectively place, if the VLQ does not contain a second packet, the first packet in the VLQ and increment a counter associated with the VLQ and the destined output port of the first packet; means to selectively place, if the VLQ contains a second packet destined for the destined output port of the first packet, the first packet in the VLQ and increment a counter associated with the VLQ and the destined output port of the first packet; and means to selectively place, if the VLQ contains a second packet destined for a different output port than the destined output port of the first packet, the first packet in a generic queue (GQ) of 7 possible GQs, allocate the GQ for the destined VL and the destined output port of the first packet, and deallocate, based on an indication of a transmission of all packets from the GQ, the GQ for the destined VL and the destined output port of the first packet.

Example 63 may include one or more non-transitory computer-readable media comprising instructions to cause a queue manager of a switch, upon execution of the instructions by one or more processors coupled with the queue manager of the switch, to: identify, based on a header of a first packet, a virtual lane (VL) of the first packet and a destined output port of the first packet; identify whether a VL queue (VLQ) of 10 VLQs that is associated with the VL of the first packet contains a second packet; selectively place, if the VLQ does not contain a second packet, the first packet in the VLQ and increment a counter associated with the VLQ and the destined output port of the first packet; selectively place, if the VLQ contains a second packet destined for the destined output port of the first packet, the first packet in the VLQ and increment a counter associated with the VLQ and the destined output port of the first packet; and selectively place, if the VLQ contains a second packet destined for a different output port than the destined output port of the first packet, the first packet in a generic queue (GQ) of 7 possible GQs, allocate the GQ for the destined VL and the destined output port of the first packet, and deallocate, based on an indication of a transmission of all packets from the GQ, the GQ for the destined VL and the destined output port of the first packet.

It will be apparent to those skilled in the art that various modifications and variations can be made in the disclosed embodiments of the disclosed device and associated methods without departing from the spirit or scope of the disclosure. Thus, it is intended that the present disclosure covers the modifications and variations of the embodiments disclosed above provided that the modifications and variations come within the scope of any claims and their equivalents.

1. A switch comprising:
a plurality of output ports;
a plurality of virtual lane queues (VLQs) communicatively coupled with the output ports, and respectively associated with a plurality of virtual lanes (VLs);
a plurality of generic queues (GQs) communicatively coupled with the output ports, and unassociated with any VL; and
a queue manager communicatively coupled with the plurality of VLQs and the plurality of GQs, the queue manager to selectively place a packet of a VL and destined for an output port of the plurality of output ports in a corresponding VLQ of the plurality of VLQs or a GQ of the plurality of GQs.

2. The switch of claim 1, wherein the queue manager is to selectively place the packet in the GQ based on a condition of the corresponding VLQ.

3. The switch of claim 2, wherein the queue manager is further to allocate, in relation to a selective placement of the packet in the GQ, the GQ as associated with a VL of the plurality of VLs and the output port.

4. The switch of claim 1, comprising 7 GQs or 10 VLQs.

5. The switch of claim 1, further comprising a crossbar coupled with the plurality of GQs, the plurality of VLQs, and the plurality of output ports.

6. The switch of claim 1, wherein the switch is an element of a system on chip (SoC) that includes the switch and one or more processors.

7. A queue manager in a switch, the queue manager comprising:
identification circuitry to identify a first data packet as a data packet of a virtual lane (VL) of a plurality of VLs and destined for an output port;
management circuitry to identify whether a VL queue (VLQ) associated with the VL is empty; and
placement circuitry to:
place the first data packet in the VLQ if the VLQ is empty; and place the first data packet in a generic queue (GQ) of a plurality of GQs if the VLQ is not empty.

8. The queue manager of claim 7, wherein the placement circuitry is further to place the first data packet in the VLQ if the VLQ contains a second data packet that is destined for the same output port as the first data packet.

9. The queue manager of claim 7, wherein the plurality of VLQs includes 10 VLQs or wherein the plurality of GQs includes 7 GQs.

10. The queue manager of claim 7, wherein the placement circuitry is further to allocate, in relation to placement of the first data packet in the GQ, the GQ for the VL of the plurality of VLs and the destined output port of the first data packet.

11. The queue manager of claim 10, wherein the placement circuitry is further to deallocate, based on an indication of a transmission of the first data packet from the GQ to the destined output port of the first data packet, the GQ for the VL of the plurality of VLs and the destined output port of the first data packet.

12. The queue manager of claim 11, wherein the placement circuitry is further to deallocate, based on an indication of a transmission of all data packets from the GQ to the destined output port of the first data packet, the GQ for the VL of the plurality of VLs and the destined output port of the first data packet.

13. The queue manager of claim 7, wherein the placement circuitry is further to increment, based on placement of the first data packet in the VLQ, a counter associated with the VLQ and the destined output port of the first data packet.

14. The queue manager of claim 7, wherein the identification circuitry is further to identify the destined output port of the first data packet based on an indication of a column of the switch.

15. One or more non-transitory computer-readable media comprising instructions to cause a queue manager of a switch, upon execution of the instructions by one or more processors coupled with the switch, to:
identify, based on a header of a first packet, a virtual lane (VL) of the first packet and an output port that is a destined output port of the first packet;
identify whether a VL queue (VLQ) associated with the VL of the first packet is empty;
place, if the VLQ is empty, the first packet in the VLQ; and
place, if the VLQ is not empty, the first packet in a generic queue (GQ) of the switch.

16. The one or more non-transitory computer-readable media of claim 15, wherein the instructions are further to place the first data packet in the VLQ if the VLQ contains a second data packet that is destined for the same output port as the first data packet.

17. The one or more non-transitory computer-readable media of claim 15, wherein the instructions are further to allocate, in relation to a placement of the first packet in the GQ, the GQ for the VL of the first packet and the destined output port.

18. The one or more non-transitory computer-readable media of claim 17, wherein the instructions are further to allocate the GQ for the VL of the first packet and a plurality of output ports that includes the destined output port.

19. The one or more non-transitory computer-readable media of claim 17, wherein the instructions are further to deallocate, based on an indication of a transmission of the first packet from the GQ to the destined output port of the first packet, the GQ for the VL of the first packet and the destined output port of the first packet.

20. The one or more non-transitory computer-readable media of claim 15, wherein the instructions are further to increment, based on a placement of the first packet in the VLQ, a counter associated with the VLQ and the destined output port of the first packet.

21. A method comprising:
identifying, by a queue manager of a switch based on a header of a first packet, an indication of a virtual lane (VL) of the switch and an indication of an output port of the switch;
identifying, by the queue manager, whether a VL queue (VLQ) associated with the VL contains a second packet;
placing, by the queue manager if the VLQ contains the second packet destined for the identified output port, the first packet in the VLQ; and
placing, by the queue manager if the VLQ contains the second packet destined for a different output port than the identified output port, the first packet in a generic queue (GQ) of the switch.

22. The method of claim 21, further comprising allocating, by the queue manager based on the placing of the first packet in the GQ, the GQ for the identified VL and the identified output port.

23. The method of claim 22, further comprising deallocating, by the queue manager based on an indication of a transmission of the first packet from the GQ to the identified output port, the GQ for the identified VL and the identified output port.

24. The method of claim 21, further comprising incrementing, by the queue manager based on the placing of the first packet in the VLQ, a counter associated with the VLQ and the identified output port.

25. The method of claim 21, further comprising identifying, by the queue manager, the identified output port of the packet based on an indication of a column of the switch in the header of the packet.
